(19) United States
(12) Patent Application Publication
(10) Pub. No.: US 2006/0102459 A1
(43) Pub. Date: May 18, 2006

(54) Clutch for an electric lock motor

(76) Inventors: Philippe Ottolini, La Voivre (FR); Jean-Marc Belmond, St. Jean Le Blance (FR); Jean-Pierre Noel, Raon L'Etape (FR)

Correspondence Address: CARLSON, GASKEY & OLDS, P.C., 400 WEST MAPLE ROAD, SUITE 350, BIRMINGHAM, MI, 48009, US

(21) Appl. No.: 11/272,048

(22) Filed: Nov. 10, 2005

(30) Foreign Application Priority Data
Nov. 12, 2004 (FR) 04 12 022

(51) Int. Cl. H01H 5/00

(52) U.S. Cl. 200/400

(57) ABSTRACT

A clutch for an electric motor includes a pinion with a groove, a hub with a cleat and a spring. The pinion is mounted freely on a drive shaft, and the hub is mounted integrally on the drive shaft. The spring includes end legs housed in the groove of the pinion and stems defining a space to receive the cleat of the hub. The pinion is driven by the hub via the spring, which can absorb the over torque generated when the motor stops by sliding in the groove. The hub, the cleat and the spring assembly offers a simple design and limited bulk.

### REFERENCE TO RELATED APPLICATION

This application claims priority to French Patent Application FR 04 12 022 filed on Nov. 12, 2004.

### BACKGROUND OF THE INVENTION

This invention relates generally to a clutch for an electric motor, in particular for a lock motor.

A lock enables an openable member, such as a door for a motor vehicle, to be held in a closed position. It also enables the openable member to be released by actuating an interior or exterior opening control connected to the lock that is able to be actuated by a user. A lock of this kind is typically mounted on the vehicle openable member.

There are numerous models of electric locks, and the opening/closing mechanism or locking/unlocking mechanism is actuated by a gear system driven by an electric motor. Electric locks can be used to perform in part or in full various functions, such as locking, unlocking, security locking, security locking release, activation/deactivation of a child-proof feature or override. For example, reference can be made to patent application EP-A-1 335 087, which describes various models of locks of the prior art, as well as an electric lock that enables the various functions mentioned above to be performed under degraded electrical conditions.

An electric lock motor drives a gear system that activates the mechanism of one of the aforementioned functions. To this end, the motor is generally equipped with a pinion integral in rotation with a rotor to drive the gear system. A clutch enables the pinion to be rendered integral with the rotation of the motor rotor.

Furthermore, the stopping of the motor can be mechanical, i.e., by a stop on the driven mechanism, for example by reaching the end of travel. A mechanical stop of this kind, rather than an electrical stop by switching off the power to the motor, is often chosen for low power motors, such as lock motors for example. When the motor is stopped by a mechanical stop, the accumulation of kinetic energy in the rotor gives rise to a considerable over torque that must be absorbed. During this transitory period in which rotation of the rotor stops, the pinion teeth receive severe mechanical stresses, which can damage the pinion and generate noise.

To limit the noise and the mechanical stresses on the pinion when the motor stops, elastic shock absorbers can be placed in the mechanical stop. However, the solution does not permit sufficient dissipation of the over torque.

Additionally, French patent application FR-A-2 642 127 describes a centrifugal clutch that drives a pinion by a spring engaged with flyweights. The spring is shaped to enclose the pinion with its ends and is bent to create a drive finger parallel to the rotor axis that cooperates with the flyweights. If the over torque exceeds a pre-determined value prescribed by the design of the spring when the motor stops, the ends of the spring slide on the pinion. The over torque is therefore not transmitted to the pinion, but dissipated by the sliding of the spring.

A solution of this kind allows for effective dissipation of the over torque generated by the rotor when the motor stops, but constitutes considerable bulk. The pinion is driven by the flyweights, which go out from the hub when there is sufficient centrifugal energy. The diameter of the clutch is approximately 20 mm.

In addition, the pinion is driven with a time delay corresponding to the time required for the rotor to reach a sufficient rotating speed to make the flyweights go out from the hub. A transmission delay of this kind in the driving of the pinion can prejudice the accuracy of the mechanism. In addition, the hub with the flyweights constitute a complex piece both for manufacture and assembly of the clutch.

A need therefore exists for a clutch for an electric motor that can absorb the over torque generated by mechanically stopping the motor that has a simplified design and limited bulk.

### SUMMARY OF THE INVENTION

The present invention provides a clutch including a pinion with a groove to be mounted freely on a drive shaft, a hub with a cleat to be mounted integrally on the drive shaft and a spring with end legs housed in the groove including stems defining a space adapted to receive the cleat of the hub.

Depending on the embodiment, the clutch according to the invention includes one or more of the following characteristics. The ends of the spring can be adapted to clamp the groove to transmit drive torque to the pinion and can be adapted to slip in the groove when an over torque is applied to the pinion. The spring can include a loop arranged in a plane substantially parallel to the plane of the end legs and connected to the legs by the stems. The spring loop can have a larger diameter than the diameter of the hub, and the spring loop can be located above the hub. The spring can have a length of between 40 and 70 mm. The hub can be housed in a central bore of the pinion, and the cleat abuts on the pinion groove. The clutch can have a diameter of between 12 and 15 mm.

The invention also provides an electric motor including a rotor constituting a drive shaft and the clutch described above mounted on the rotor. The invention may also be applied to an electric lock including a motor according to the invention.

### BRIEF DESCRIPTION OF THE DRAWINGS

Other characteristics and advantages of the invention will become apparent on reading the following detailed description of the embodiments of the invention, given as an example only and with reference to the drawings, which show:

FIG. 1 illustrates an exploded diagram of a motor with a clutch according to the invention;

FIG. 2 illustrates a diagram of the motor in FIG. 1 assembled; and

FIG. 3 illustrates a detailed view of a clutch pinion and a spring according to the invention.

### DETAILED DESCRIPTION OF THE INVENTION

The clutch according to the invention includes a pinion with a groove, a hub with a cleat and a spring. The clutch is located between an electric motor and a gear system of a mechanism to be driven. The pinion is mounted freely on a drive shaft, such as the rotor of the motor, and the hub is mounted integrally on the drive shaft. The spring includes end legs housed in the pinion groove and includes stems defining a space adapted to receive the cleat of the hub.

The pinion is thus driven by the hub by the spring, which is able to absorb the over torque generated when the motor stops by sliding in the groove. The hub with the cleat and spring assembly offers a simple design and limited bulk. A clutch of this kind is particularly suitable for a low power motor of approximately 5 to 6 Watts, for example for an actuating motor for a vehicle openable member lock mechanism.

In the following description, the expression “above” is used with reference to the appended Figures and does not limit the final arrangement of the motor in the lock.

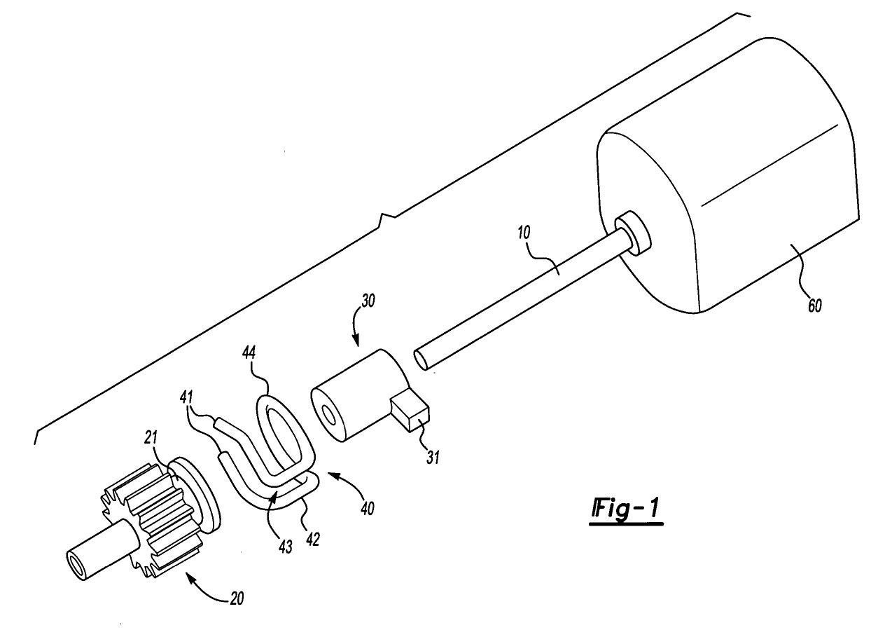

FIG. 1 is an exploded view of a motor 60 including a clutch according to the invention. FIG. 1 shows a motor 60 including a stator frame and a rotor 10 constituting a drive shaft. FIG. 1 also shows the clutch designed to be mounted on the rotor 10 to drive a gear system of a drive mechanism (not shown).

The clutch includes a hub 30 made up of a cylindrical body designed to be rendered integral with the rotor 10, for example by tight fitting onto the rotor 10. The hub 30 includes a cleat 31 that is either a single piece with or added onto the hub 30. The cleat 31 constitutes a drive finger integral with the rotor 10. The hub 30 can have an external diameter of 8 to 10 mm, and the cleat 31 can constitute a radial projection from the hub 30 of 3 to 5 mm.

The clutch also includes a pinion 20 having a toothed wheel designed to be mounted free to rotate on the rotor 10. The pinion 20 also includes a circular groove 21 formed above the toothed wheel. The pinion 20 can be made of molded plastic, for example. The pinion 20 can include a bore such that the internal diameter of the toothed wheel is sufficient to receive the cylindrical body of the hub 30 and thus serve as a bearing for the hub 30. The hub 30 can then be inserted into the bore of the pinion 20 with the cleat 31 abutting against the top of the groove 21.

The clutch also includes a spring 40 constituted of a steel rod shaped to have coplanar curved end legs 41 that adapt to the shape of the groove 21 of the pinion 20. FIG. 3 shows in detail the spring 40 housed in the groove 21 of the pinion 20. The spring 40 also includes stems 42 that define a space 43 between the stems 42 and adapted to receive the cleat 31 of the hub 30. The stems 42 are substantially parallel to each other and may be perpendicular to the end legs 41. The above mentioned angles may vary slightly depending on the exact shape of the cleat 31 and the groove 21.

The end legs 41 of the spring 40 can be completed by a loop 44 shaped in a parallel plane to that of the end legs 41 to lengthen the spring 40 and give it the elasticity required to enable it to effectively absorb the kinetic energy from the braking of the motor 60. The spring 40 with the loop 44 can have a length of between 40 and 70 mm, which allows absorption of 50 to 70 mN/m of over torque before slipping in the groove 21.

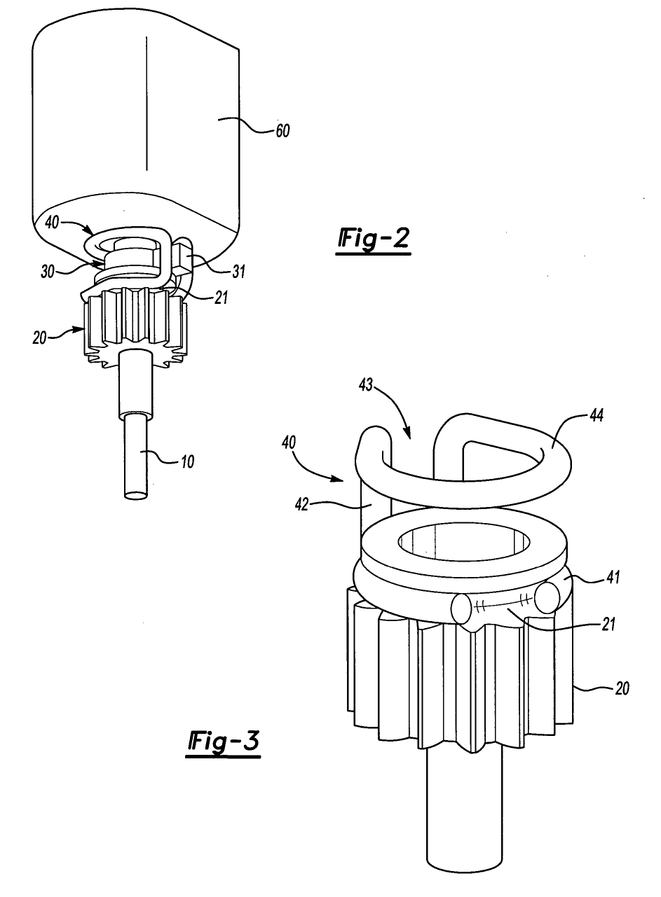

FIG. 2 shows the motor in FIG. 1 assembled. The hub 30 is mounted on the rotor 10 and is housed in the bore of the pinion 20 with the cleat 31 protruding and abutting on the pinion 20. The looped spring 40 is clipped around the hub 30 and the pinion 20, enclosing the groove 21 of the pinion 20 with the end legs 41 and the cleat 31 between the stems 42 perpendicular to the legs 41.

When the spring 40 is assembled in the clutch, the loop 44 formed above the end legs 41 is located above the hub 30 and has a larger diameter than that of the hub 30. With this shape of the spring 40 relative to the dimensions of the hub 30, the cleat 31 can be held firmly between the stems 42 of the spring 40 to ensure effective driving of the pinion 20.

The assembly forming the clutch according to the invention is very compact with a bulk contained within a diameter of 12 to 15 mm. The clutch functions as follows. When the motor 60 is started on the command of a power supply to transmit a current to the commutator brushes (not shown), the rotor 10 begins to turn.

The rotation of the rotor 10 drives the hub 30 mounted integrally on the rotor 10. The cleat 31, located in the space 43 defined by the stems 42 of the spring 40, drives the spring 40 in rotation with the hub 30, i.e., in integrally rotation with the rotor 10.

The clamping force of the spring 40 is chosen so that the end legs 41 clamp the groove 21 of the pinion 20 sufficiently tightly to drive the pinion 20 in integrally rotation with the rotor 10. Drive torque is thus transmitted by the motor 60 to the pinion 20, which can drive a gear system actuating a given mechanism.

When the motor 60 is stopped by reaching the end of travel of the driven mechanism against a mechanical stop, the rotor 10 continues to rotate under the effect of the inductive load stored by the stator windings of the motor 60, while the rotation of the pinion 20 is blocked by stopping the gear system that it drives.

Moreover, the hub 30 integral with the rotor 10 is still turning, and the cleat 31 is therefore still driving the spring 40, which clamps the pinion 20. The clamping force of the spring 40 is chosen so that, above a pre-determined over torque, the end legs 41 slip in the groove 21 of the pinion 20, and the rotation of the pinion 20 is blocked to absorb the kinetic energy of the rotor 10.

The clamping force is therefore chosen as a function of the maximum over torque to be applied to the pinion 20, i.e., it depends among other factors on the power of the motor 60 and the size of the pinion 20.

Of course, this invention is not limited to the embodiments described as an example. Accordingly, although the description may refer to a lock motor, the clutch according to the invention can be adapted to any type of low power motor for a function other than locks.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A clutch comprising:
a pinion including a groove, wherein the pinion is mounted freely on a drive shaft;
a hub including a cleat, wherein the hub is mounted integrally on the drive shaft; and
a spring including end legs and stems, wherein the end legs are housed in the groove of the pinion and the stems define a space that receives the cleat of the hub.

2. The clutch according to claim 1, wherein the end legs of the spring clamp the groove to transmit a drive torque to the pinion, and the end legs of the spring slide in the groove when over torque is applied to the pinion.

3. The clutch according to claim 1, wherein the spring includes a loop arranged in a loop plane substantially parallel to a leg plane of the end legs, and the loop is connected to the end legs by the stems.

4. The clutch according to claim 3, wherein the loop includes a loop diameter and the hub includes a hub diameter, and the loop diameter is greater than the hub diameter.

5. The clutch according to claim 3, wherein the loop is located above the hub.

6. The clutch according to claim 1, wherein the spring has a length of between approximately 40 and 70 mm.

7. The clutch according to claim 1, wherein the pinion includes a central bore, and the hub is housed in the central bore with the cleat abutting the groove of the pinion.

8. The clutch according to claim 1, wherein the clutch has a diameter between approximately 12 and 15 mm.

9. An electric motor comprising:
a rotor constituting a drive shaft; and
a clutch mounted on the rotor, the clutch including:
a pinion including a groove, wherein the pinion is mounted freely on the drive shaft,
a hub including a cleat, wherein the hub is mounted integrally on the drive shaft, and
a spring including end legs and stems, wherein the end legs are housed in the groove of the pinion and the stems define a space that receives the cleat of the hub.

10. The electric motor according to claim 9, wherein the end legs of the spring clamp the groove to transmit a drive torque to the pinion, and the end legs of the spring slide in the groove when over torque is applied to the pinion.

11. The electric motor according to claim 9, wherein the spring includes a loop arranged in a loop plane substantially parallel to a leg plane of the end legs, and the loop is connected to the end legs by the stems.

12. The electric motor according to claim 11, wherein the loop includes a loop diameter and the hub includes a hub diameter, wherein the loop diameter is greater than the hub diameter.

13. The electric motor according to claim 11, wherein the loop is located above the hub.

14. The electric motor according to claim 9, wherein the spring has a length of between approximately 40 and 70 mm.

15. The electric motor according to claim 9, wherein the pinion includes a central bore, and the hub is housed in the central bore with the cleat abutting the groove of the pinion.

16. The electric motor according to claim 9, wherein the clutch has a diameter between approximately 12 and 15 mm.

17. An electric lock comprising:
a rotor constituting a drive shaft; and
a clutch mounted on the rotor, the clutch including:
a pinion including a groove, wherein the pinion is mounted freely on the drive shaft;
a hub including a cleat, wherein the hub is mounted integrally on the drive shaft; and
a spring including end legs and stems, wherein the end legs are housed in the groove of the pinion and the stems define a space that receives the cleat of the hub.

18. The electric lock according to claim 17, wherein the end legs of the spring clamp the groove to transmit a drive torque to the pinion, and the end legs of the spring slide in the groove when over torque is applied to the pinion.

19. The electric lock according to claim 17, wherein the spring includes a loop arranged in a loop plane substantially parallel to a leg plane of the end legs, and the loop is connected to the end legs by the stems.

20. The electric lock according to claim 17, wherein the pinion includes a central bore, and the hub is housed in the central bore with the cleat abutting the groove of the pinion.

21. The electric lock according to claim 17, wherein the clutch drives a gear system of the electric lock.
